(19) United States
(12) Patent Application Publication
(10) Pub. No.: US 2025/0085751 A1
(43) Pub. Date: Mar. 13, 2025

(54) Thermal Power Budget Optimization Method, Heating device and Thermal Power Budget Optimization System

(71) Applicant: MEDIATEK INC., Hsin-Chu (TW)

(72) Inventors: Yu-Chia Chang, Hsinchu City (TW); Chien-Chih Huang, Hsinchu City (TW); Ta-Chang Liao, Hsinchu City (TW); Chia-Feng Yeh, Hsinchu City (TW); Ching-Lin Hsiao, Hsinchu City (TW); Wei-Te Wu, Hsinchu City (TW)

(73) Assignee: MEDIATEK INC., Hsin-Chu (TW)

(21) Appl. No.: 18/788,086

(22) Filed: Jul. 29, 2024

Related U.S. Application Data
(60) Provisional application No. 63/537,192, filed on Sep. 7, 2023.

(51) Int. Cl. G06F 1/20; G06F 1/3234

(52) U.S. Cl. CPC G06F 1/203; G06F 1/3234

(57) ABSTRACT

A thermal power budget optimization method includes acquiring sensor log information from a plurality of sensors of a heating device, generating a virtual surface temperature of the heating device according to the sensor log information, setting a target surface temperature of the heating device, and dynamically adjusting a thermal power budget of the heating device according to the virtual surface temperature and the target surface temperature over time.

### CROSS REFERENCE TO RELATED APPLICATIONS

This application claims the benefit of U.S. Provisional Application No. 63/537,192, filed on Sep. 7, 2023. The content of the application is incorporated herein by reference.

### BACKGROUND

With the rapid advancement of technologies, various foldable phones are adopted in our diary life. A foldable phone is a smartphone with a folding form factor. When a folding angle of the foldable phone is changed, the physical heat dissipation capacity of the phone is changed accordingly. For example, when the foldable phone is closed, an inner side of a surface of the foldable phone is not well-ventilated. Only outer case of the foldable phone can dissipate heat. In another case, when the foldable phone is opened, the foldable phone is well-ventilated.

Currently, a surface temperature management of the foldable phone lacks adjusting a power budget according to a hinge angle. As a result, a foldable phone surface temperature may be overheated. Further, the operational performance of the foldable phone may not be optimized at a target surface temperature.

Therefore, developing a thermal Power budget optimization method for controlling the surface temperature and the operational performance of the foldable phone is an important design issue.

### SUMMARY

In an embodiment of the present invention, a thermal power budget optimization method is disclosed. The thermal power budget optimization method comprises acquiring sensor log information from a plurality of sensors of a heating device, generating a virtual surface temperature of the heating device according to the sensor log information, setting a target surface temperature of the heating device, and dynamically adjusting a thermal power budget of the heating device according to the virtual surface temperature and the target surface temperature over time.

In another embodiment of the present invention, a heating device is disclosed. The heating device comprises a plurality of sensors; at least one heating source; a storage device; a cache memory; a processor coupled to the plurality of sensors, the at least one heating source, the storage device, and the cache memory; and a case configured to cover the plurality of sensors, the at least one heating source, the storage device, the cache memory, and the processor; wherein the processor is configured to acquire sensor log information from the plurality of sensors of the heating device, the processor is further configured to generate a virtual surface temperature of the heating device according to the sensor log information, the processor is further configured to set a target surface temperature of the heating device, the processor is further configured to dynamically adjust a thermal power budget of the heating device according to the virtual surface temperature and the target surface temperature over time, and the sensor log information, the virtual surface temperature, the target surface temperature, and the thermal power budget are buffered in the cache memory.

In another embodiment of the present invention, a thermal power budget optimization system is disclosed. The thermal power budget optimization system comprises a heating device, a memory, and a first processor. The heating device comprises a plurality of sensors, at least one heating source, a storage device, a cache memory, a second processor coupled to the plurality of sensors, the at least one heating source, the storage device, and the cache memory, and a case configured to cover the plurality of sensors, the at least one heating source, the storage device, the cache memory, and the second processor. The first processor is coupled to the heating device and the memory. The second processor acquires sensor log information from the plurality of sensors of the heating device. The second processor generates a virtual surface temperature of the heating device according to the sensor log information. The second processor sets a target surface temperature of the heating device. The second processor dynamically adjusts a thermal power budget of the heating device according to the virtual surface temperature and the target surface temperature over time. The sensor log information, the virtual surface temperature, the target surface temperature, and the thermal power budget are buffered in the cache memory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a thermal power budget optimization system according to an embodiment of the present invention.

FIG. 2 is an illustration of data flows of training a surface temperature prediction model of the thermal power budget optimization system in FIG. 1.

FIG. 3 is an illustration of data flows of controlling at least one heating source according to a thermal power budget of the thermal power budget optimization system in FIG. 1.

FIG. 4 is an illustration of adjusting the thermal power budget over time of the thermal power budget optimization system in FIG. 1.

FIG. 5 is a flow chart of performing a thermal power budget optimization method by the thermal power budget optimization system in FIG. 1.

### DETAILED DESCRIPTION

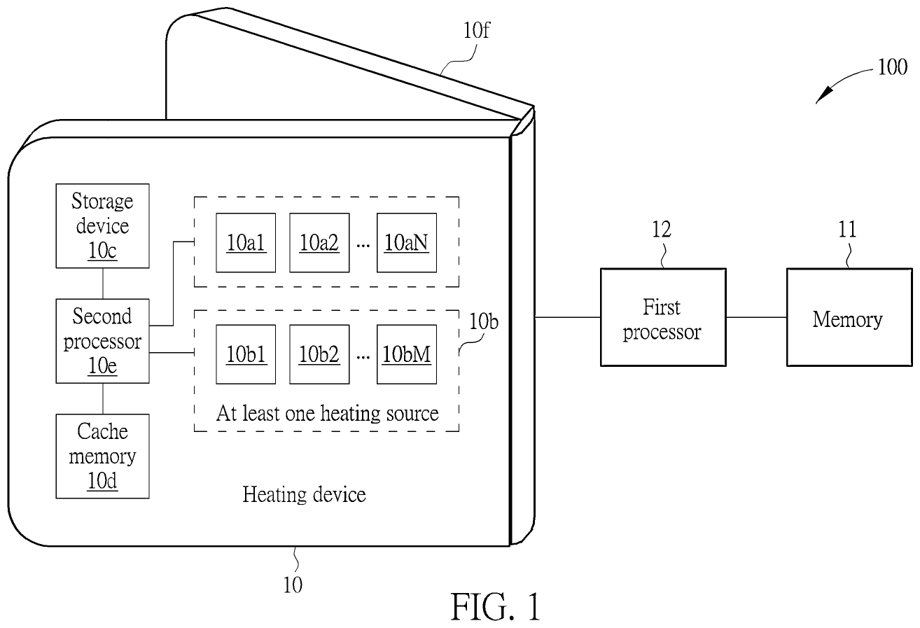

FIG. 1 is a block diagram of a thermal power budget optimization system 100 according to an embodiment of the present invention. The thermal power budget optimization system 100 includes a heating device 10, a memory 11, and a first processor 12. The heating device 10 can be any electronic heating device, such as a foldable phone, or a notebook. The heating device 10 includes a plurality of sensors 10a1 to 10aN, at least one heating source 10b, a storage device 10c, a cache memory 10d, a second processor 10e, and a case 10f. The plurality of sensors 10a1 to 10aN can generate sensor log information. For example, the plurality of sensors 10a1 to 10aN can include at least one thermal sensor, a hinge angle sensor, a gravity sensor, an accelerometer, and a gyroscope sensor. N is a positive integer greater than two. At least one heating source 10b can be a central processing unit (CPU), a graphics processing unit (GPU), and/or any electronic driver device. For example, the heating source 10b1 can be the CPU. The heating source 10b2 can be the GPU. Here, M is a positive integer. The storage device 10c can be configured to save data, such as a hard disk or non-volatile memory. The cache memory 10d can be used for buffering data, such dynamic random-access memory (DRAM), static random-access memory (SRAM), or any kind of high-speed data accessing memory. The second processor 10e can be a processing chip of the heating device 10. The case 10f is used for covering the plurality of sensors 10a1 to 10aN, the at least one heating source 10b, the storage device 10c, the cache memory 10d, and the second processor 10e. The first processor 12 is coupled to the heating device 10 and the memory 11. It should be understood that the first processor 12 and the memory 11 can be integrated in an external device, such as a computer or a work station. A purpose of the thermal power budget optimization system 100 is to adjust the operational performance of the heating device 10 at a target surface temperature of the case 10f. In the thermal power budget optimization system 100, the second processor 10e can acquire sensor log information from the plurality of sensors 10a1 to 10aN of the heating device 10. After a surface temperature prediction model is completely trained, the second processor 10e can generate a virtual surface temperature of the case 10f of the heating device 10 according to the sensor log information by using a trained surface temperature prediction model. The second processor 10e sets the target surface temperature of the case 10f of the heating device 10. The second processor 10e can dynamically adjust a thermal power budget of the heating device 10 according to the virtual surface temperature and the target surface temperature over time. In the thermal power budget optimization system 100, since the second processor 10e can dynamically adjust the thermal power budget of the heating device 10 according to the virtual surface temperature and the target surface temperature over time, the second processor 10e can dynamically control operations of at least one heating source 10b according to the thermal power budget over time. Here, the sensor log information, the virtual surface temperature, the target surface temperature, and the thermal power budget are buffered in the cache memory 10d. Details of optimizing the thermal power budget by the thermal power budget optimization system 100 are illustrated below.

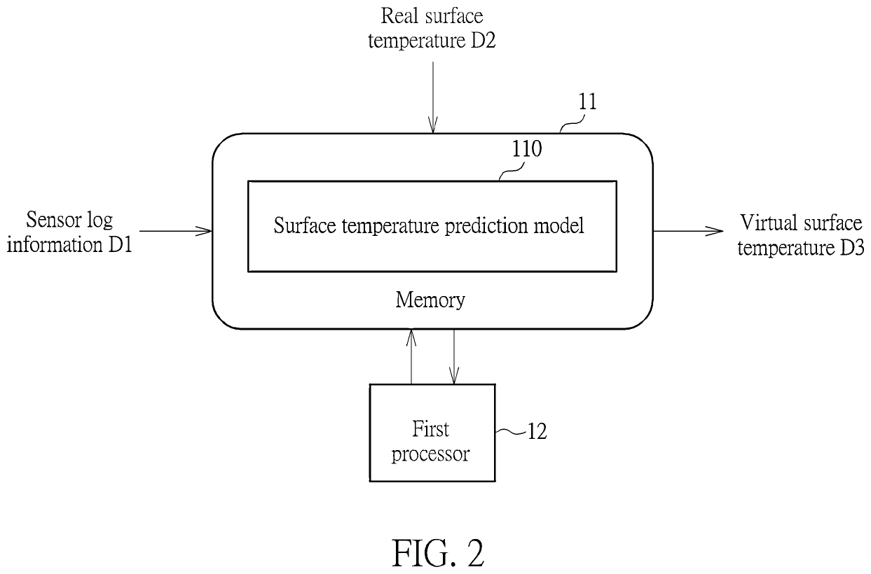

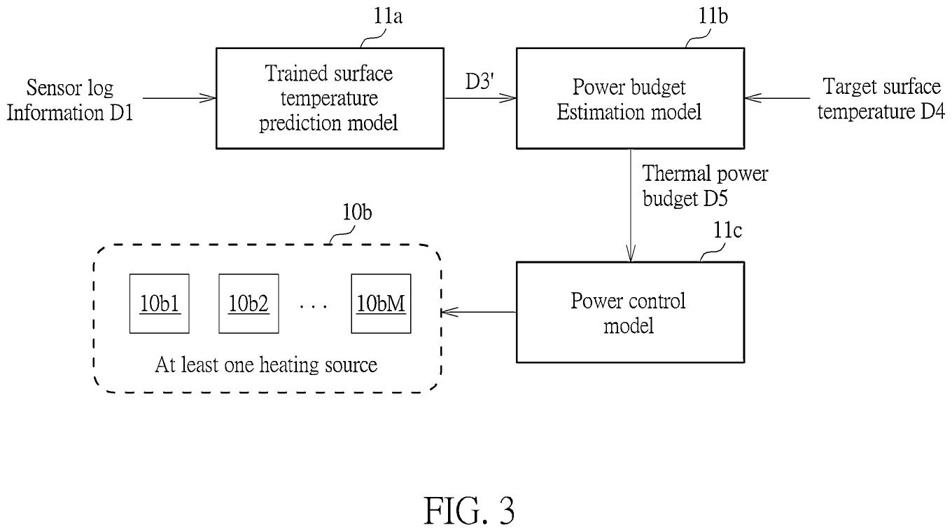

FIG. 2 is an illustration of data flows of training a surface temperature prediction model 110 of the thermal power budget optimization system 100. As previously mentioned, the plurality of sensors 10a1 to 10aN can acquire the sensor log information D1. For example, when the heating device 10 is a foldable phone, the sensor log information D1 can include placement scenarios of the foldable phone and a core temperature of the foldable phone. Here, placement scenarios can include a folded mode, a flex mode (cover screen), a flex mode (main screen), and an unfolded mode of the foldable phone. Further, the placement scenarios can also include a flex mode (main screen) and an unfolded mode of a flip phone. However, the placement scenarios detected by the plurality of sensors 10a1 to 10aN of the foldable phone are not limited to aforementioned embodiments. Any reasonable sensor log information D1 generated by the plurality of sensors 10a1 to 10aN falls into the scope of the present invention. In FIG. 2, the first processor 12 can acquire a real surface temperature D2 of the case 10f of the heating device 10. For example, a series of the real surface temperatures D2 can be obtained by using a thermocouple attached to the surface of the case 10f periodically. A series of the sensor log information D1 can be obtained by using a debugging tool of the foldable phone. In FIG. 2, the sensor log information D1 and the real surface temperatures D2 can be inputted to the surface temperature prediction model 110 for outputting a virtual surface temperature D3. Then, the first processor 12 can train the surface temperature prediction model 110 of the heating device 10 according to the sensor log information D1, the real surface temperature D2, and the virtual surface temperature D3. For example, an error (i.e., or say, a difference or a mean square error) between the real surface temperature D2 and the virtual surface temperature D3 can be detected for determining whether the surface temperature prediction model 110 is completely trained. In an embodiment, the first processor 12 can pre-set a threshold. Further, the first processor 12 can compare the difference between the real surface temperature D2 and the virtual surface temperature D3 with the threshold. When the difference between the real surface temperature D2 and the virtual surface temperature D3 is smaller than the threshold, it implies that the surface temperature prediction model 110 is completely trained. The prediction accuracy is satisfactory. Therefore, the surface temperature prediction model 110 can be regarded as a “trained” surface temperature prediction model (11a in FIG. 3). In another embodiment, the first processor 12 can select the surface temperature prediction model 110 from a plurality of training models as a “trained” surface temperature prediction model (11a in FIG. 3) which makes the virtual surface temperature closest to the real surface temperature compared to other training models. In other words, after the surface temperature prediction model 110 is completely trained or appropriately selected as the “trained” surface temperature prediction model 11a, the trained surface temperature prediction model 11a can be regarded as a neutral network training model having the best fit between the real surface temperature D2 and the virtual surface temperature D3 compared with other training models.

FIG. 3 is an illustration of data flows of controlling at least one heating source according to a thermal power budget of the thermal power budget optimization system 100. After the trained surface temperature prediction model 11a is generated and saved in the memory 11 by the first processor 12, the first processor 12 can transmit the trained surface temperature prediction model 11a from the memory 11 to the storage device 10c of the heating device 10. When a process of controlling the at least one heating source is started, the second processor 10e controls the cache memory 10d to buffer the trained surface temperature prediction model 11a from the storage device 10c. Then, the sensor log information D1 is inputted to the trained surface temperature prediction model 11a by the second processor 10e. The virtual surface temperature D3′ is outputted from the trained surface temperature prediction model 11a. Then, the virtual surface temperature D3′ can be inputted to a power budget estimation model 11b. The power budget estimation model 11b can be a software program saved in the cache memory 10d and can be performed by the second processor 10e. It should be understood that the virtual surface temperature D3 in FIG. 2 is defined as inferred data outputted from the surface temperature prediction model 110 under a training stage. The virtual surface temperature D3′ in FIG. 3 is defined as inferred data outputted from the trained surface temperature prediction model 11a under an inference stage. The target surface temperature D4 can be inputted to the power budget estimation model 11b. Here, the target surface temperature D4 can be configured by phone manufacturers according to user scenarios. Generally, a lower surface temperature of the heating device 10 (foldable phone) can provide a better user experience. In an embodiment, when the user watches YouTube videos, the temperature of the case 10f of the heating device 10 must not exceed 40 degrees Celsius (the temperature value here is just for example, not intend to limit this disclosure). In another embodiment, when the user plays heavy games, the target surface temperature D4 can be set as 48 degrees Celsius (the temperature value here is just for example, not intend to limit this disclosure). After the virtual surface temperature D3′ and the target surface temperature D4 are inputted to the power budget estimation model 11b, the thermal power budget D5 can be generated, as illustrated below.

In the thermal power budget optimization system 100, the power budget estimation model 11b can generate the thermal power budget D5 by using the following equation.

$$D 5 = sustainable power budget + {f}_{est} ( D {3}^{′} , D 4 )$$

Here, the thermal power budget D5 can be regarded as a new thermal power budget generated by the second processor 10e according to a sustainable power budget and a function-estimated power budget fₑₛₜ (D3′, D4). The sustainable power budget is a maximum power of operating the heating device 10 over a prolonged period without exceeding the target surface temperature D4. It can be understood that one real surface temperature D2 can be mapped into a corresponding sustainable power budget. Correlations between the real surface temperature D2 and the corresponding sustainable power budget can be saved as a mapping table in the storage device 10c. The function-estimated power budget fₑₛₜ (D3′, D4) is a proportional integral derivative (PID) function fₑₛₜ (.) output. Here, the function-estimated power budget fₑₛₜ (D3′, D4) can be generated according to the virtual surface temperature D3′ and the target surface temperature D4. For example, when the virtual surface temperature D3′ is greater than the target surface temperature D4, the function-estimated power budget fₑₛₜ (D3′, D4) can be decreased for avoiding overheating of the heating device 10. When the virtual surface temperature D3′ is smaller than the target surface temperature D4, the function-estimated power budget fₑₛₜ (D3′, D4) is increased for boosting the operational performance of the heating device 10. In FIG. 3, after the thermal power budget D5 is generated, the thermal power budget D5 can be inputted to a power control model 11c. The power control model 11c can be a software program saved in the storage device 10c and can be performed by the second processor 10e. The power control model 11c can control at least one heating source 10b. As a result, the thermal power budget optimization system 100 can optimize operational performance of at least one heating source 10b (i.e., such as the CPU and GPU) of the heating device 10 at the target surface temperature D4.

In the thermal power budget optimization system 100, the training stage and the inference stage for surface temperature prediction model is introduced. FIG. 2 illustrates the training stage of training the surface temperature prediction model 110 according to the sensor log information D1, the real surface temperature D2, and the virtual surface temperature D3. After the training the surface temperature prediction model 110 is completely trained, in FIG. 3, the trained surface temperature prediction model 11a can be used for inferring the virtual surface temperature D3′ according to the sensor log information D1. Therefore, the trained surface temperature prediction model 11a, the power budget estimation model 11b, and the power control model 11c in FIG. 3 can be performed by software programs or chips in the heating device 10.

In the thermal power budget optimization system 100, as previously mentioned, the first processor 12 and the memory 11 can be integrated in the external device, such as the computer or the work station. Since computing power requirement of training the surface temperature prediction model in the training stage is very large, the first processor 12 of the external device can be used for achieving model training processes. However, the model training processes can be achieved by using a cloud server or a cloud work station through a network. In other embodiments, when the computing power of the heating device 10 is sufficient, the model training processes can be achieved by using the heating device 10. Any technology or hardware modification falls into the scope of the present invention.

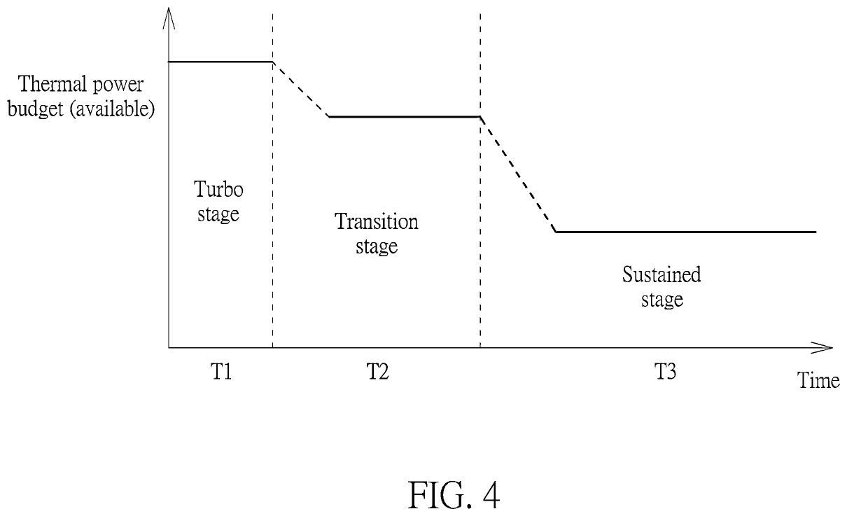

FIG. 4 is an illustration of adjusting the thermal power budget over time of the thermal power budget optimization system 100. As previously mentioned, the thermal power budget D5 can be generated by the power budget estimation model 11b according to the virtual surface temperature D3′ and the target surface temperature D4. Further, the thermal power budget D5 (or say, an available total power budget) can be adjusted over time. For example, in FIG. 4, the thermal power budget D5 can be dynamically adjusted by the second processor 10e during a turbo stage, a transition stage, or a sustained stage. The transition stage follows the turbo stage. The sustained stage follows the transition stage. For example, a time duration T1 of the turbo stage can be 30 seconds. A time duration T2 of the transition stage can be 5˜20 minutes. A time duration T3 of the sustained stage can be greater than 30 minutes. Particularly, when the case 10f of the heating device 10 is cold, it implies that the temperature of the case 10f has not yet reached the target surface temperature D4. Therefore, in FIG. 4, the thermal power budget D5 during the turbo stage is greater than the thermal power budget D5 during the transition stage. Further, the thermal power budget D5 during the transition stage is greater than the thermal power budget D5 during the sustained stage.

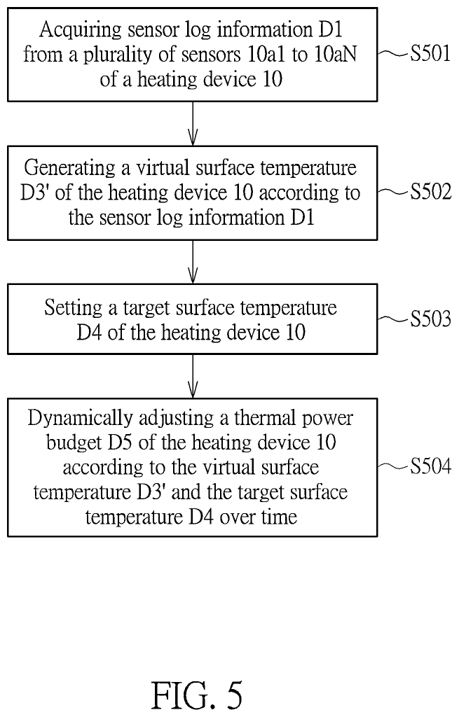

FIG. 5 is a flow chart of performing a thermal power budget optimization method by the thermal power budget optimization system 100. The thermal power budget optimization method includes step S501 to step S504. Any reasonable technology or hardware modification falls into the scope of the present invention. Step S501 to step S504 are illustrated below.
step S501: acquiring sensor log information D1 from a plurality of sensors 10a1 to 10aN of a heating device 10;
step S502: generating a virtual surface temperature D3′ of the heating device 10 according to the sensor log information D1;
step S503: setting a target surface temperature D4 of the heating device 10;
step S504: dynamically adjusting a thermal power budget D5 of the heating device 10 according to the virtual surface temperature D3′ and the target surface temperature D4 over time.

Details of step S501 to step S504 are previously illustrated. Thus, they are omitted here. In the thermal power budget optimization system 100, the thermal power budget can be dynamically adjusted over time. Since the thermal power budget can be adjusted, operational performances the heating sources (such as the CPU and GPU) can be optimized at the target surface temperature. Further, the thermal power budget optimization system 100 can be manually enabled or disabled by users. The thermal power budget optimization system 100 can be enabled or disabled by specific trigger conditions, such as a timer, or specific operation on the screen. Any reasonable design of the thermal power budget optimization system 100 falls into the scope of the present invention.

To sum up, the present invention discloses a thermal power budget optimization method and a thermal power budget optimization system. The thermal power budget optimization system introduces a surface temperature prediction model for predicting a virtual surface temperature. Then, the virtual surface temperature and a target surface temperature can be compared for generating a thermal power budget. The thermal power budget can be adjusted over time. Therefore, the operational performances of the heating sources (such as the CPU and GPU) can also be adjusted according to the thermal power budget over time. As a result, the thermal power budget optimization system can optimally adjust the operational performance of the heating device at the target surface temperature.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A thermal power budget optimization method comprising:
acquiring sensor log information from a plurality of sensors of a heating device;
generating a virtual surface temperature of the heating device according to the sensor log information;
setting a target surface temperature of the heating device; and
dynamically adjusting a thermal power budget of the heating device according to the virtual surface temperature and the target surface temperature over time.

2. The method of claim 1, further comprising:
acquiring a real surface temperature of the heating device; and
executing model training according to the sensor log information and the real surface temperature for obtaining a trained surface temperature prediction model of the heating device.

3. The method of claim 2, wherein generating the virtual surface temperature of the heating device according to the sensor log information comprises:
inputting the sensor log information to the trained surface temperature prediction model to generate the virtual surface temperature.

4. The method of claim 3, wherein the trained surface temperature prediction model is configured to ensure the difference between the virtual surface temperature and the real surface temperature less than a threshold, or the trained surface temperature prediction model is configured to ensure the virtual surface temperature closest to the real surface temperature compared to other training models.

5. The method of claim 1, wherein dynamically adjusting a thermal power budget comprises generating a new thermal power budget according to a sustainable power budget and a function-estimated power budget, the sustainable power budget is a pre-determined power budget, and the function-estimated power budget is a proportional integral derivative (PID) function output generated according to the virtual surface temperature and the target surface temperature.

6. The method of claim 5, wherein the sustainable power budget is obtained according to a real surface temperature.

7. The method of claim 5, wherein when the virtual surface temperature is greater than the target surface temperature, the function-estimated power budget is decreased, and when the virtual surface temperature is smaller than the target surface temperature, the function-estimated power budget is increased.

8. The method of claim 1, wherein the thermal power budget is dynamically adjusted during a turbo stage, a transition stage, or a sustained stage, the transition stage follows the turbo stage, and the sustained stage follows the transition stage.

9. The method of claim 8, wherein a first thermal power budget in the turbo stage is greater than a second thermal power budget in the transition stage, and the second thermal power budget in the transition stage is greater than a third thermal power budget in the sustained stage.

10. A heating device, comprises:
a plurality of sensors;
at least one heating source;
a storage device;
a cache memory;
a processor coupled to the plurality of sensors, the at least one heating source, the storage device, and the cache memory; and
a case configured to cover the plurality of sensors, the at least one heating source, the storage device, the cache memory, and the processor;
wherein the processor is configured to acquire sensor log information from the plurality of sensors of the heating device, the processor is further configured to generate a virtual surface temperature of the heating device according to the sensor log information, the processor is further configured to set a target surface temperature of the heating device, the processor is further configured to dynamically adjust a thermal power budget of the heating device according to the virtual surface temperature and the target surface temperature over time, and the sensor log information, the virtual surface temperature, the target surface temperature, and the thermal power budget are buffered in the cache memory.

11. The heating device of claim 10, wherein the storage device is configured to receive a trained surface temperature prediction model from a memory outside of the heating device, the processor is further configured to control the cache memory to buffer the trained surface temperature prediction model from the storage device, the processor is further configured to input the sensor log information to the trained surface temperature prediction model to generate the virtual surface temperature.

12. The heating device of claim 11, wherein the trained surface temperature prediction model is configured to ensure a difference between the virtual surface temperature and the real surface temperature less than a threshold, or the trained surface temperature prediction model is configured to ensure the virtual surface temperature closest to the real surface temperature compared to other training models.

13. The heating device of claim 10, wherein the processor is further configured to generate a new thermal power budget according to a sustainable power budget and a function-estimated power budget, the sustainable power budget is a pre-determined power budget, and the function-estimated power budget is a proportional integral derivative (PID) function output generated according to the virtual surface temperature and the target surface temperature.

14. The heating device of claim 13, wherein the sustainable power budget is obtained according to a real surface temperature.

15. The heating device of claim 13, wherein when the virtual surface temperature is greater than the target surface temperature, the function-estimated power budget is decreased, and when the virtual surface temperature is smaller than the target surface temperature, the function-estimated power budget is increased.

16. The heating device of claim 10, wherein the thermal power budget is dynamically adjusted by the processor during a turbo stage, a transition stage, or a sustained stage, the transition stage follows the turbo stage, and the sustained stage follows the transition stage.

17. The heating device of claim 16, wherein a first thermal power budget in the turbo stage is greater than a second thermal power budget in the transition stage, and the second thermal power budget in the transition stage is greater than a third thermal power budget in the sustained stage.

18. The heating device of claim 10, wherein the heating device is a foldable phone, or a notebook.

19. A thermal power budget optimization system comprising a heating device, a memory, and a first processor coupled to the heating device and the memory, wherein the heating device comprises:
a plurality of sensors;
at least one heating source;
a storage device;
a cache memory;
a second processor coupled to the plurality of sensors, the at least one heating source, the storage device, and the cache memory; and
a case configured to cover the plurality of sensors, the at least one heating source, the storage device, the cache memory, and the second processor;
wherein the second processor is configured to acquire sensor log information from the plurality of sensors of the heating device, the second processor is further configured to generate a virtual surface temperature of the heating device according to the sensor log information, the second processor is further configured to set a target surface temperature of the heating device, the second processor is further configured to dynamically adjust a thermal power budget of the heating device according to the virtual surface temperature and the target surface temperature over time, and the sensor log information, the virtual surface temperature, the target surface temperature, and the thermal power budget are buffered in the cache memory.

20. The system of claim 19, wherein the first processor is configured to acquire a real surface temperature of the case of the heating device, the first processor is further configured to execute model training according to the sensor log information and the real surface temperature for obtaining a trained surface temperature prediction model of the heating device, and the trained surface temperature prediction model is saved in the memory;
wherein the storage device is configured to receive the trained surface temperature prediction model from the memory, the second processor is further configured to control the cache memory to buffer the trained surface temperature prediction model from the storage device, the second processor is further configured to input the sensor log information to the trained surface temperature prediction model to generate the virtual surface temperature.
